(19) United States
(12) Patent Application Publication
(10) Pub. No.: US 2026/0031334 A1
(43) Pub. Date: Jan. 29, 2026

(54) ELECTROCHEMICAL DEVICE

(71) Applicant: Panasonic Intellectual Property Management Co., Ltd., Osaka (JP)

(72) Inventors: Shohei MASUDA, Hokkaido (JP); Nobuhiro SHIMAMURA, Osaka Fu (JP); Hideo SAKATA, Osaka Fu (JP)

(73) Assignee: Panasonic Intellectual Property Management Co., Ltd., Osaka (JP)

(21) Appl. No.: 19/112,833

(22) PCT Filed: Aug. 30, 2023
(86) PCT No.: PCT/JP2023/031563

§ 371 Date: Mar. 18, 2025

(30) Foreign Application Priority Data
Sep. 22, 2022 (JP) 2022-151681

(51) Int. Cl. H01M 4/36; H01M 4/02; H01M 4/587; H01M 4/62; H01M 50/417

(52) U.S. Cl. CPC H01M 4/366; H01M 4/587; H01M 50/417; H01M 2004/021; H01M 2004/027; H01M 4/625

(57) ABSTRACT

An electrochemical device includes a positive electrode, a negative electrode, a separator, and a lithium-ion conductive electrolyte. The positive electrode includes a current collector, and a mixture layer which is supported on the current collector and into which anions are reversibly doped. The negative electrode includes a negative electrode current collector, and a mixture layer which is supported on the current collector and into which lithium ions are reversibly doped. A length L1 of the negative electrode mixture layer in a first direction is longer than a length L2 in a second direction orthogonal to the first direction. A state of charge of two end regions adjacent to both ends of the negative electrode mixture layer in the second direction is X %, a state of charge of a center region of the negative electrode mixture layer in the second direction is Y %, and X<Y is satisfied.

### TECHNICAL FIELD

The present invention relates to an electrochemical device.

### BACKGROUND ART

Electrochemical devices that combine the power storage principle of lithium-ion secondary batteries and that of electric double layer capacitors have been attracting attention in recent years. In such electrochemical devices, usually, a polarizable electrode is used for the positive electrode, and a non-polarizable electrode is used for the negative electrode. As a result, the electrochemical devices are expected to have both high energy density of lithium-ion secondary batteries and high output characteristics of electric double layer capacitors (Patent Literature 1).

Patent Literature 2 proposes “a method for producing a negative electrode active material for lithium-ion capacitors, the method including kneading carbon black having an average particle diameter of 12 to 300 nm as measured by electron microscopy and a BET specific surface area of 200 to 1500 m²/g, together with a carbon precursor, followed by baking at 800° C. to 3200° C., and pulverizing, to adjust the average particle diameter (D50) to 1 to 20 μm and the BET specific surface area to 110 m²/g or more and 350 m²/g or less.”

### CITATION LIST

### Patent Literature

Patent Literature 1: Japanese Laid-Open Patent Publication No. 2017-195231
Patent Literature 2: Japanese Patent No. 6356145

### SUMMARY OF INVENTION

### Technical Problem

In electrochemical devices such as lithium-ion capacitors, the negative electrode is pre-doped with lithium ions. Therefore, metal lithium tends to deposit on the negative electrode. The deposited metal lithium can be a cause of internal short-circuiting. One of the objectives of the present disclosure is to suppress the deposition of metal lithium on the negative electrode.

### Solution to Problem

One aspect of the present invention relates to an electrochemical device, including
a positive electrode, a negative electrode, a separator, and a lithium-ion conductive electrolyte, wherein
the positive electrode includes a positive electrode current collector, and a positive electrode mixture layer which is supported on the positive electrode current collector and into which anions are reversibly doped,
the negative electrode includes a negative electrode current collector, and a negative electrode mixture layer which is supported on the negative electrode current collector and into which lithium ions are reversibly doped,
a length L1 of the negative electrode mixture layer in a first direction is longer than a length L2 in a second direction orthogonal to the first direction,
a state of charge of two end regions adjacent to both ends of the negative electrode mixture layer in the second direction is X %,
a state of charge of a center region of the negative electrode mixture layer in the second direction is Y %, and
X<Y is satisfied.

### Advantageous Effects of Invention

According to the present invention, it is possible to suppress the deposition of metal lithium on the negative electrode in the electrochemical device.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWING

A longitudinal sectional view showing a configuration of an electrochemical device of one embodiment of the present invention.

### DESCRIPTION OF EMBODIMENTS

Embodiments of the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. In the present specification, the phrase “a numerical value A to a numerical value B” includes the numerical value A and the numerical value B, and can be rephrased as “a numerical value A or more and a numerical value B or less.” In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit.

The present disclosure encompasses a combination of matters recited in any two or more claims selected from plural claims in the appended claims. In other words, as long as no technical contradiction arises, matters recited in any two or more claims selected from plural claims in the appended claims can be combined.

In the following description, the term “comprise” or “include” is an expression including meanings of “comprise (or include),” “essentially consist of,” and “consist of.”

An electrochemical device according to one embodiment of the present invention includes a positive electrode, a negative electrode, a separator, and a lithium-ion conductive electrolyte. In general, the positive electrode and the negative electrode, together with a separator interposed therebetween, constitute an electrode body. The electrode body is, for example, formed as a columnar wound body by winding a belt-like positive electrode and a belt-like negative electrode, with a separator interposed therebetween. The electrode body may be formed as a stack by stacking a positive electrode and a negative electrode each having a plate-like shape, with a separator interposed therebetween.

The positive electrode includes a positive electrode current collector, and a positive electrode mixture layer which is supported on the positive electrode current collector and into which anions are reversibly doped. The positive electrode mixture layer contains at least a positive electrode active material into which anions are reversibly doped. Doping of anions into the positive electrode mixture layer or the positive electrode active material is a concept that includes at least the adsorption phenomenon of anions into the positive electrode active material. The concept can also include chemical interactions of anions with the positive electrode active material, and like. In the positive electrode mixture layer, at least a non-Faradaic reaction in which anions are reversibly adsorbed and desorbed proceeds, to develop capacity.

The negative electrode includes a negative electrode current collector, and a negative electrode mixture layer which is supported on the negative electrode current collector and into which lithium ions are reversibly doped. The negative electrode mixture layer contains at least a negative electrode active material into which lithium ions are reversibly doped. Doping of lithium ions into the negative electrode mixture layer or the negative electrode active material is a concept that includes at least the absorption phenomenon of lithium ions into the negative electrode active material. The concept can also include adsorption of lithium ions onto the negative electrode active material and chemical interactions between the negative electrode active material and lithium ions, and the like. In the negative electrode mixture layer, at least a Faradaic reaction in which lithium ions are reversibly absorbed and released proceeds, to develop capacity.

A typical example of such an electrochemical device as above is a lithium ion capacitor. The positive electrode of a lithium ion capacitor is usually a polarizable electrode. The positive electrode of a polarizable electrode develops capacity through adsorption and desorption of anions into and from the positive electrode active material. The positive electrode active material includes, for example, a carbon material (activated carbon etc.). The positive electrode may be an electrode having the properties of a polarizable electrode, in which the Faradaic reaction also contributes to the positive electrode capacity. Such an electrode contains, for example, a π-conjugated conductive polymer as a positive electrode active material. The conductive polymer may be doped with a dopant. The electrochemical device may also be called a power storage device.

### (Negative Electrode)

The negative electrode includes a negative electrode current collector and a negative electrode mixture layer. The negative electrode active material into which lithium ions are reversibly doped includes, for example, hard carbon (non-graphitizable carbon). The thickness of the negative electrode mixture layer, although not limited to, for example, may be 10 μm to 300 μm per side of the negative electrode current collector.

For the negative electrode current collector, a sheet-like metal material is used. The sheet-like metal material may be a metal foil, a metal porous body, an etched metal, and the like. As the metal material, copper, copper alloy, nickel, stainless steel, and the like can be used.

The non-graphitizable carbon may have an interplanar spacing d002 of the (002) plane measured by X-ray diffractometry (i.e., interplanar spacing between carbon layers) of 3.8 Å or more. The theoretical capacity of the non-graphitizable carbon is desirably, for example, 150 mAh/g or more. Using a non-graphitizable carbon makes it easy to obtain a negative electrode whose DCR at low temperatures is small and whose expansion and contraction during charging and discharging is small. The non-graphitizable carbon desirably occupies 50 mass % or more, further 80 mass % or more, and further 95 mass % or more of the negative electrode active material. In addition, the non-graphitizable carbon desirably occupies 40 mass % or more, further 70 mass % or more, and further 90 mass % or more of the negative electrode mixture layer.

As the negative electrode active material, a non-graphitizable carbon and a material other than non-graphitizable carbon may be used in combination. Examples of the material other than non-graphitizable carbon that can be used as the negative electrode active material include graphitizable carbon (soft carbon), graphite (natural graphite, artificial graphite, etc.), lithium titanium oxide (spinel-type lithium titanium oxide, etc.), silicon oxide, silicon alloy, tin oxide, and tin alloy.

In view of high packability of the negative electrode active material in the negative electrode and suppression of side reactions with the electrolyte, the average particle diameter of the negative electrode active material (esp., non-graphitizable carbon) is preferably 1 μm to 20 μm, more preferably 2 μm to 15 μm.

In the present specification, the average particle diameter means a volume-based median diameter (D50) in a particle size distribution obtained by laser diffraction particle size distribution measurement.

The shape of the negative electrode is regulated by the shape of the negative electrode current collector. The shape of the negative electrode current collector is usually rectangular, and the shape of the negative electrode mixture layer is also usually rectangular. A length L1 of the negative electrode mixture layer in a first direction (longitudinal direction) is longer than a length L2 in a second direction (lateral direction) orthogonal to the first direction. The rectangle includes a long belt-like shape. The shape of an electrode body to be configured as a columnar wound body usually has a belt-like shape. The length L1 of the negative electrode mixture layer in the first direction may be two or more times as long as the length L2 in the second direction, or may be three or more times. When the negative electrode has a belt-like shape, an example of the preferred range of L1/L2 is 8 to 20.

The negative electrode mixture layer has two end regions adjacent to both ends in the second direction. Here, the width of each of the end regions in the second direction is defined as 10% of L2. That is, when the negative electrode mixture layer is equally divided into ten stripe-like regions extending in the first direction as viewed from the direction normal to the negative electrode mixture layer, the two outermost regions in the second direction are the end regions. In short, 20% of the negative electrode mixture layer is the end regions.

The negative electrode mixture layer has one center region including the center in the second direction. Here, the width of the center region in the second direction is defined as 40% of L2. In the center region, the distances from the center in the second direction to both ends in the second direction are the same. That is, when the negative electrode mixture layer is equally divided into ten stripe-like regions extending in the first direction as viewed from the direction normal to the negative electrode mixture layer, two centermost regions adjacent to the center in the second direction and two regions adjacent to the centermost regions (a total of four regions) are the center region.

Here, when the state of charge (SOC-E) of the end regions of the negative electrode mixture layer is denoted as X %, and the state of charge (SOC-C) of the center region is denoted as Y %, the negative electrode mixture layer is formed such that the relationship X<Y is satisfied. The SOC-E may be an average of the two end regions. Note that X<Y being satisfied means that the Y is 1.05 times or more as large as the X. When X<Y is satisfied, the deposition of metal lithium on the negative electrode can be suppressed.

The state of charge (SOC) of the negative electrode mixture layer refers to, when a maximum amount of lithium ions to be reversibly absorbed in the negative electrode mixture layer is taken as 100%, the ratio of an amount of lithium ions having been reversibly absorbed in the negative electrode mixture layer, relative to the maximum amount.

The end-of-charge voltage of the electrochemical device to be a subject of the present disclosure is, for example, 3.0 V to 4.3 V, and the end-of-discharge voltage is, for example, 2.0 V to 2.5 V. The rated voltage is, for example, 3.2 V to 4.0 V. Therefore, it suffices as long as the relationship X<Y is satisfied when the voltage of the electrochemical device (i.e., the potential difference between the positive electrode and the negative electrode) is, for example, 3 V. Usually, X<Y is always satisfied at a voltage between the end-of-charge voltage and the end-of-discharge voltage. An example of the end-of-charge voltage is 3.8 V, and an example of the end-of-discharge voltage is 2.2 V. For example, when X<Y is satisfied at 3V, the deposition of metal lithium on the negative electrode can be suppressed.

However, in some cases, simply designing the SOC-E and the SOC-C as described above is insufficient. In order to reduce the internal resistance of the electrochemical device and ensure high reliability (e.g., excellent float characteristics), it is desirable to set the specific surface area of the negative electrode mixture layer to 10 m²/g to 70 m²/g.

The float characteristics are an index of the degree of degradation of an electrochemical device when float charging is performed by keeping the device at a constant voltage using an external DC power source. It can be said that the smaller the decrease in capacity is, and the smaller the increase in internal resistance during float charging is, the more excellent the float characteristics are.

When the specific surface area of the negative electrode mixture layer is 10 m²/g or more, the resistance of the negative electrode is significantly reduced, and the internal resistance of the electrochemical device is significantly reduced. When the specific surface area of the negative electrode mixture layer is 70 m²/g or less, the reactivity of the negative electrode will not be too high, and the degradation of the negative electrode is likely to be suppressed. Therefore, excellent reliability can be obtained. However, the larger the specific surface area of the negative electrode mixture layer is, the more the irreversible capacity is increased, which necessitates a large amount of lithium ions to be pre-doped. On such an electrode, metal lithium is likely to deposit. It is more desirable to set the specific surface area of the negative electrode mixture layer to 20 m²/g to 60 m²/g. On an electrode having a specific surface area of 20 m²/g or more, metal lithium is more likely to deposit.

In this regard, even when a negative electrode mixture layer having a high specific surface area is formed, by designing the SOC-E and the SOC-C more meticulously as below, it becomes possible to suppress the deposition of metal lithium with high probability while ensuring high reliability.

The specific surface area of the negative electrode mixture layer is a BET specific surface area obtained using a measuring instrument conforming to JIS Z8830 (e.g., TriStar II 3020 available from Shimadzu Corporation). Specifically, the electrochemical device is disassembled, from which the negative electrode is taken out. Using this negative electrode as a working electrode and a Li metal foil as a counter electrode, a half-cell is assembled, and Li in the negative electrode is de-doped until the negative electrode potential reaches 1.5 V. Next, the negative electrode from which Li has been de-doped is washed with dimethyl carbonate (DMC), and dried. Then, the negative electrode mixture layer is peeled off from the negative electrode current collector, to collect about 0.5 g of a sample of the negative electrode mixture layer.

Next, the collected sample is heated at 150° C. for 12 hours in a reduced pressure of 95 kPa or less, and then, nitrogen gas is adsorbed onto the sample with a known mass, to obtain an adsorption isotherm in the relative pressure range of 0 to 1. Then, using a monomolecular layer adsorption amount of the gas obtained from the adsorption isotherm, the surface area of the sample is calculated. Here, a specific surface area is calculated from the following BET formula using the BET single point method (relative pressure 0.3).

$$P / V ( P 0 - P ) = ( 1 / VmC ) + \{ ( C - 1 ) / VmC \} ( P / P 0 ) \qquad ( 1 )$$

$$S = kVm \qquad ( 2 )$$

P0: saturated vapor pressure
P: adsorption equilibrium pressure
V: adsorption amount at adsorption equilibrium pressure P
Vm: monomolecular layer adsorption amount
C: parameter related to adsorption heat etc.
S: specific surface area
k: area occupied by one molecule of nitrogen 0.162 nm²

The difference (Y−X) between X and Y, for example, may be 5% to 30%, may be 10% to 30%, and may be 15% to 25%. When there is a difference of 5% or more between X and Y, the deposition of metal lithium on the end regions can be suppressed with high probability while the reliability of the electrochemical device is ensured. Furthermore, by setting the difference between X and Y to 30% or less, a sufficient amount of lithium ions are pre-doped in the end regions, and the reliability of the electrochemical device can be improved.

When the potential difference between the positive electrode and the negative electrode is 3.0 V, 65%≤X≤85%, and 75%≤Y≤95% may be satisfied, 65%≤X≤80% and 80%≤Y≤95% may be satisfied, and 70%≤X≤80% and 85%≤Y≤95% may be satisfied.

When X is 65% or more or 70% or more, a sufficient amount of lithium ions is pre-doped in the end regions, too. Therefore, high reliability of the electrochemical device can be ensured. When X is 85% or less or 80% or less, the end regions have a sufficient leeway for absorbing lithium ions. Therefore, deposition of metal lithium on the end regions can be suppressed with high probability.

When Y is 75% or more, or 80% or more, or 85% or more, the internal resistance is lowered and high reliability can be ensured. When Y is 95% or less, the deposition of metal lithium can be highly suppressed while high reliability is ensured.

The SOC of the negative electrode mixture layer can change depending on the duration of use, the duration of storage, etc. of the electrochemical device. Therefore, the above values of SOC-E and SOC-C are values measured for the electrochemical device in an initial state as a product. The initial state may be, for example, a state in which not much time has passed since it was completed as a product. The initial state includes, for example, a product within two months after its completion, and may be in an unused state.

The SOC-E and the SOC-C can be each measured by cutting out a portion of the negative electrode mixture layer, together with the negative electrode current collector, from the end region or the center region (preferably a region including the center in the second direction), to prepare a sample electrode. The sample electrode may be, for example, a circular electrode having a diameter of 1 mm to 6 mm (preferably 6 mm). Specifically, a sample cell including a metal lithium foil as a counter electrode and a sample electrode as a working electrode is prepared. A single-layered microporous membrane (e.g., 16 μm to 25 μm thick) made of polypropylene (PP) is interposed as a separator between the metal lithium foil and the sample electrode. The electrolyte solution of the sample cell may be an electrolyte solution having the same composition as that of the electrochemical device in which the negative electrode mixture layer has been housed, or may be an electrolyte solution having any composition suitable for charging and discharging the sample cell. Next, the lithium ions contained in the working electrode are discharged until the voltage of the sample cell reaches 1.5 V. Next, lithium ions are charged from the counter electrode into the working electrode until the voltage of the sample cell reaches the lowest (e.g., until it reaches 1 mV or less). The current for charging and discharging is set to about 0.1 mA/cm² (e.g., 0.9 mA/cm² to 1.1 mA/cm²). From the charge capacity obtained at this time, the SOC-E and the SOC-C can be calculated.

The negative electrode mixture layer may contain a conductive additive. As the conductive additive, a carbon material can be used. The conductive additive may be a carbon black, carbon fibers, and the like. Examples of the carbon black include acetylene black (AB) and Ketjen black (KB). In particular, it is desirable to use Ketjen black in terms of its large specific surface area.

In order to increase the specific surface area of the negative electrode mixture layer, it is effective to contain carbon black as a conductive additive in the negative electrode mixture layer. The specific surface area of the negative electrode mixture layer can reflect the specific surface areas of the negative electrode active material and the conductive additive. By using a conductive additive with a high specific surface area, the specific surface area of the negative electrode mixture layer can be effectively increased, and the internal resistance of the negative electrode can be easily reduced. The specific surface area of the conductive additive is, for example, desirably 800 m²/g or more, and may be 1000 m²/g or more. An example of such a conductive additive is carbon black (e.g., Ketjen black).

The volume fractions of the respective negative electrode mixture components including a conductive additive in the negative electrode mixture layer can be calculated by observing a cross section of the negative electrode mixture layer with a scanning electron microscope (SEM). From the obtained volume fractions and the specific surface area of the negative electrode mixture layer, the type and specific surface area of the conductive additive can be estimated. The volume fraction of each negative electrode mixture component is calculated, with the ratio of the area occupied by each negative electrode mixture component in the cross section image regarded as the ratio of the volume. The area ratio can be determined by analyzing the SEM image with an image analysis software.

The ratio of a mass of the conductive additive to a mass of the negative electrode mixture layer is desirably, for example, 2% or more and less than 15%, may be 3% or more and 12% or less, and may be 4% or more and 11% or less. Within the above range, the resistance of the negative electrode can be suppressed to be sufficiently small and excellent reliability (esp., float characteristics) can be easily ensured.

The negative electrode mixture layer contains a negative electrode active material, and a binder that binds the negative electrode active material to the negative electrode current collector. The binder contains at least a first component, and may contain a second component other than the first component. The first component is at least one selected from the group consisting of carboxymethyl cellulose and a carboxymethyl cellulose salt (hereinafter, at least one selected from the group consisting of carboxymethyl cellulose and a carboxymethyl cellulose salt is sometimes referred to as “CMC”).

The ratio of a mass of the first component (CMC) to a mass of the negative electrode mixture layer is, for example, 2% or more, may be 3% or more, and may be 4% or more. The ratio of the mass of the first component (CMC) to the mass of the negative electrode mixture layer is, for example, 6.5% or less, may be 6.0% or less, and may be 5.5% or less. Within this range, the resistance of the negative electrode can be suppressed to be sufficiently small, and the negative electrode mixture layer can be bound to the negative electrode current collector with high strength.

When a carboxymethyl cellulose salt is used as the CMC, the salt may be a sodium salt, a lithium salt, a potassium salt, an ammonium salt, and the like. In particular, the carboxymethyl cellulose salt desirably includes an ammonium salt. An ammonium salt of carboxymethylcellulose, among CMCs, is especially unlikely to increase the resistance of the negative electrode.

The ratio of a mass of the second component to a mass of the negative electrode mixture layer is 0% or more 3% or less, may be 0% or more and 2% or less, and may be 0% or more and less than 1%. In other words, the second component may not necessarily be used.

As the second component, a fluorocarbon resin, an acrylic resin, a rubbery material, and the like can be used. Examples of the fluorocarbon resin include polytetrafluoroethylene (PTFE), polyvinylidene fluoride (PVDF), modified products of PVDF, tetrafluoroethylene-perfluoroalkyl vinyl ether copolymer (PFA), and tetrafluoroethylene-hexafluoropropylene copolymer (FEP). Examples of the acrylic resin include polyacrylic acid and acrylic acid-methacrylic acid copolymer. Examples of the rubbery material include styrene butadiene rubber (SBR).

With regard to the peeling strength of the negative electrode mixture layer from the negative electrode current collector, it is desirable to ensure, for example, 0.015 N/mm or more. This peeling strength is a sufficient peeling strength in view of manufacturing process and also in view of ensuring product characteristics. By increasing the amount of CMC used, it is possible to secure a peeling strength of 0.04 N/mm or more, or even 0.05 N/mm or more, while ensuring product characteristics.

The peeling strength of the negative electrode mixture layer from the negative electrode current collector is obtained using a measuring instrument conforming to JIS Z0237 (2009). Specifically, the electrochemical device is disassembled, from which the negative electrode is taken out. The negative electrode is washed with dimethyl carbonate (DMC) and dried. Then, the negative electrode is formed into a belt-like sample having a width of 10 mm and a length of 50 mm or more. Next, one surface of a double-sided tape having a width of 20 mm and a length of 130 mm (e.g., No. 5606 available from Nitto Denko Corporation) is attached to the negative electrode mixture layer of the sample. The other surface of the double-sided tape is attached to a horizontal table having a flat surface. Then, one end of the negative electrode current collector in the length direction is fixed with a force gauge and pulled vertically at a speed of 50 mm/min, to peel off the negative electrode mixture layer attached to the double-sided tape from the negative electrode current collector. The tension during peeling is measured for 15 seconds or more, and the average tension in a continuous 15-second section is calculated.

The negative electrode mixture layer is formed by, for example, mixing a negative electrode mixture with a dispersion medium, to prepare a negative electrode slurry, applying the negative electrode slurry to a negative electrode current collector, followed by drying. The negative electrode mixture includes a negative electrode active material, a binder, a conductive additive, and the like.

The negative electrode mixture layer is pre-doped with lithium ions in advance. With the negative electrode mixture layer pre-doped with lithium ions in advance, the potential of the negative electrode decreases, increasing the potential difference (i.e., voltage) between the positive electrode and the negative electrode. This results in improved energy density of the electrochemical device.

The negative electrode potential is, for example, 0.2 V or less based on lithium (vs. Li/Li⁺). This negative electrode potential corresponds to the negative electrode potential (25° C.) when pre-doping is completed (or during charging). The amount of lithium to be pre-doped is set according to the negative electrode potential in the electrolyte after the completion of pre-doping.

The surface layer portion of the negative electrode mixture layer may have a first layer containing lithium carbonate. The first layer is mainly formed on the surface of the negative electrode active material. Usually, the larger the specific surface area of the negative electrode mixture layer is, the more the float characteristics tend to deteriorate. However, by forming the first layer, the degradation of the negative electrode is significantly suppressed, and the deterioration in float characteristics is suppressed.

The surface layer portion of the negative electrode mixture layer may have a second layer containing a solid electrolyte. At least a part of the second layer can cover at least a part of the surface of the negative electrode mixture layer via the first layer. The second layer has a different composition from the first layer, and the second layer is distinguishable from the first layer. In an electrochemical device utilizing lithium ions, a solid electrolyte interface film (i.e., SEI film) is formed on the negative electrode mixture layer during charging and discharging. The second layer may be formed as an SEI film.

The SEI film plays an important role in the charge-discharge reactions, but if the SEI film is formed too thick, the degradation of the negative electrode becomes severe. In contrast, the first layer containing lithium carbonate facilitates the formation of a good SEI film, and acts to maintain the SEI film in a favorable condition when charging and discharging are repeated. Therefore, by forming a first layer in the surface layer of the negative electrode mixture layer, it is possible to significantly suppress the degradation of the negative electrode even when the specific surface area of the negative electrode mixture layer is increased in order to reduce the resistance of the negative electrode.

When the negative electrode mixture layer has a first layer and a second layer, at least a part of the second layer covers at least a part of the surface of the negative electrode active material via the first layer. That is, at least a part of the first layer is covered with the second layer. The first layer is interposed between the surface of the negative electrode active material and the second layer, and serves as a foundation layer of the second layer. By the first layer serving as the foundation layer, the second layer is formed as an SEI film in a favorable condition.

The second layer may also contain lithium carbonate. When the second layer contains lithium carbonate, the lithium carbonate content in the second layer is smaller than that in the first layer. By using the first layer containing a large amount of lithium carbonate as the foundation layer, the second layer is formed as an SEI film in a more favorable condition.

The first layer can be formed in the surface layer portion of the negative electrode mixture layer before assembling the electrochemical device. In an electrochemical device assembled using that negative electrode, through subsequent charging and discharging, a second layer (SEI film) being homogeneous and having an appropriate thickness is formed on the surface of the negative electrode active material. The SEI film is formed, for example, by the reaction between the electrolyte and the negative electrode within the electrochemical device. Since the electrolyte can pass through not only the second layer but also the first layer, the surface layer portion as a whole including the first layer and the second layer may be referred to as the SEI film, but in the present specification, for the sake of convenience, the second layer is referred to as the SEI film and is distinguished from the first layer.

The presence of a region like the first layer in which lithium carbonate is contained can be recognized, for example, by analyzing the surface layer portion by X-ray photoelectron spectroscopy (XPS). The analysis method, however, is not limited to XPS.

The thickness of the first layer may be any thickness that is, for example, 1 nm or more, and may be set to 5 nm or more when expecting a longer-term effect, and may be set to 10 nm or more when expecting a more reliable effect. However, when the thickness of the first layer exceeds 50 nm, the first layer itself can become a resistance component. Therefore, the thickness of the first layer may be set to 50 nm or less, and may be set to 30 nm or less. The thickness of the first layer is, for example, 1 nm to 50 nm.

The thickness of the second layer may be any thickness that is, for example, 1 nm or more, and may be 3 nm or more, and a thickness of 5 nm or more is sufficient. However, when the thickness of the second layer exceeds 20 nm, the second layer itself can become a resistance component. Therefore, the thickness of the second layer may be set to 20 nm or less, or may be set to 10 nm or less.

The ratio A/B of a thickness A of the first layer to a thickness B of the second layer is preferably 1 or less in view of reducing the resistance of the negative electrode. In this case, the thickness of the second layer is preferably 20 nm or less, and may be 10 nm or less. However, in view forming a second layer in a favorable condition, it is desirable that the A/B is 0.1 or more, and for example, the A/B ratio may be 0.2 or more.

The thicknesses of the first layer and the second layer are measured by analyzing the surface layer portion of the negative electrode mixture layer at a plurality of points (at least 5 points) of the negative electrode mixture layer. The average of the thicknesses of the first or second layer obtained at the plurality of points may be taken as the thickness of the first or second layer. The negative electrode mixture layer to be used as a measurement sample may be peeled off from the negative electrode current collector. In this case, analysis is made on the film formed on the surface of the negative electrode active material constituting the vicinity of the surface layer portion of the negative electrode mixture layer. Specifically, from a region of the negative electrode mixture layer located on the side opposite to the surface joined to the negative electrode current collector, the negative electrode active material covered with the film may be sampled and used for analysis.

The XPS analysis of the surface layer portion of the negative electrode mixture layer is performed by, for example, within the chamber of an X-ray photoelectron spectrometer, irradiating an argon beam onto the surface layer portion or the film formed on the surface of the negative electrode active material, and observing and recording the changes in the spectra attributed to C1s electrons, O1s electrons, etc., respectively, versus the irradiation time. At this time, in view of avoiding analytical errors, the spectrum of the outermost surface of the surface layer portion may be ignored. The thickness of a region where peaks attributed to lithium carbonate are stably observed corresponds to the thickness of the first layer.

In a negative electrode taken out from a completed electrochemical device that has been subjected to a predetermined aging or at least one cycle of charging and discharging, the surface layer portion of the negative electrode mixture layer has an SEI film (i.e., a second layer) containing a solid electrolyte. The thickness of a region where peaks attributed to the bond that a compound contained in the SEI coating are stably observed corresponds to the thickness of the SEI film (i.e., the thickness of the second layer).

As the compound contained in the SEI film, a compound containing an element that can serve as a label for the second layer is selected. As the element that can serve as a label for the second layer, for example, an element that is contained in the electrolyte and is not substantially contained in the first layer (e.g., F) may be selected. As the compound containing an element that can serve as a label for the second layer, LiF can be selected, for example.

If the second layer contains LiF, a substantial peak of Fis attributed to the LiF bond is observed when the second layer is measured by X-ray photoelectron spectroscopy. In this case, the thickness of a region where peaks attributed to the LiF bond are stably observed corresponds to the thickness of the second layer.

On the other hand, the first layer is usually free of LiF, and even when the first layer is measured by X-ray photoelectron spectroscopy, no substantial peak of F1s attributed to the LiF bond is observed. Accordingly, the thickness of a region where peaks attributed to the LiF bond are not stably observed may be regarded as the thickness of the first layer.

In the SEI film, too, an O1s peak attributed to lithium carbonate can be observed. However, the SEI film produced in the electrochemical device has a different composition than that of the first layer formed in advance, and thus, the two are distinguishable from each other. For example, in the XPS analysis of the SEI film, an F1s peak attributed to the LiF bond is observed, but no substantial peak of F1s attributed to the LiF bond is observed in the first layer. Also, the amount of lithium carbonate contained in the SEI film is very small. As the Li1s peak, for example, a peak derived from a compound, such as ROCO₂Li or ROLi, can be detected.

When the first layer is analyzed by XPS, a second peak of O1s attributed to the Li—O bond may be observed in addition to the first peak of O1s attributed to the C═O bond. A regio of the film that is present near the surface of the negative electrode active material may contain a slight amount of LiOH or Li₂O.

Specifically, when the first layer constituting the surface layer portion of the negative electrode mixture layer is analyzed in the depth direction, in the order of increasing distance from the outermost surface of the surface layer portion, a first region and a second region may be observed. The first region is a region in which a first peak (O1s attributed to C═O bond) and a second peak (O1s attributed to Li—O bond) are observed, and the first peak intensity is greater than the second peak intensity. The second region is a region in which the first peak and the second peak are observed, and the second peak intensity is greater than the first peak intensity. A third region may also be present, which is closer to the outermost surface of the surface layer portion than the first region, and in which the first peak is observed but the second peak is not observed. The third region is likely to be observed when the thickness of the lithium carbonate-containing region is large.

The relationship between the peak intensities can be determined by the heights of the peaks from the baseline.

In the center of the first layer in the thickness direction, usually, a C1s peak attributed to the C—C bond is substantially not observed, or if observed, the peak intensity is equal to or less than a half of the intensity of a peak attributed to the C═O bond.

Next, a description will be given below of a method of forming a first layer containing lithium carbonate in the surface layer portion of the negative electrode mixture layer. The step of forming the first layer may be performed by, for example, a gas phase method, a coating method, a transfer method, or the like.

As the gas phase method, chemical vapor deposition, physical vapor deposition, sputtering, and other methods can be used. For example, a vacuum deposition apparatus may be used to attach lithium carbonate to the surface of the negative electrode mixture layer. The pressure in the chamber of the apparatus during deposition is set to, for example, 10⁻² to 10⁻⁵ Pa, the temperature of a lithium carbonate evaporation source may be 400 to 600° C., and the temperature of the negative electrode mixture layer may be −20 to 80° C.

As the coating method, the first layer can be formed by applying a solution or dispersion containing lithium carbonate onto a surface of the negative electrode using, for example, a micro gravure coater, followed by drying. The lithium carbonate content in the solution or dispersion is, for example, 0.3 to 2 mass %, and when using a solution, the concentration may be equal to or lower than the degree of solubility (e.g., about 0.9 to 1.3 mass % when using an aqueous solution at room temperature).

A negative electrode can be obtained by further performing a step of forming a second layer containing a solid electrolyte, so as to cover at least a part of the first layer. The surface layer portion of the obtained negative electrode mixture layer has a first layer and a second layer. The second layer is formed such that at least a part thereof covers at least a part of the surface (preferably, the entire surface) of the negative electrode active material via the first layer (i.e., with the first layer placed as a foundation layer).

The step of forming a second layer, which is performed while the negative electrode mixture layer is in contact with the electrolyte, may also serve as at least part of a step of pre-doping lithium ions into the negative electrode material. As the source of lithium ions to be pre-doped, metal lithium is used, for example.

Metal lithium may be attached to the surface of the negative electrode mixture layer. A negative electrode having a negative electrode mixture layer to which metal lithium is attached may be exposed to a carbon dioxide atmosphere. This can form a first layer containing lithium carbonate and having a thickness of, for example, 1 nm or more and 50 nm or less.

The step of attaching metal lithium to the surface of the negative electrode mixture layer can be performed by, for example, a gas phase method, a transfer method, or the like. As the gas phase method, chemical vapor deposition, physical vapor deposition, sputtering, and other methods can be used. For example, a vacuum deposition apparatus may be used to form metal lithium in the form of a film on the surface of the negative electrode mixture layer. The pressure in the chamber of the apparatus during deposition is set to, for example, 10⁻² to 10⁻⁵ Pa, the temperature of a lithium evaporation source may be 400 to 600° C., and the temperature of the negative electrode mixture layer may be −20 to 80° C.

The negative electrode mixture layer satisfying X<Y can be formed by, for example, vapor-depositing metal lithium selectively on the center region of the negative electrode mixture layer. By vapor-depositing metal lithium on the center region in an amount that allows the SOC to reach, for example, 90% or more, lithium ions can be pre-doped into the negative electrode mixture layer such that the SOC gradually decreases from the center region toward the end regions. In this case, it is not necessary to vapor-deposit metal lithium on the end regions. Preferably, metal lithium is vapor-deposited selectively on the center region of the negative electrode mixture layer so that the difference (Y−X) between X and Y becomes 5% or more and 30% or less when the potential difference between the positive electrode and the negative electrode is 3.0 V. Metal lithium may be vapor-deposited on the entire area of the center region of the negative electrode mixture layer. Metal lithium may be vapor-deposited on a part of the center region. By appropriately selecting the region on which metal lithium is vapor-deposited and the amount of metal lithium, a negative electrode that satisfies 65%≤X≤85% and 75%≤Y≤95% when the potential difference between the positive electrode and the negative electrode is 3.0 V can be easily obtained.

The carbon dioxide atmosphere is desirably a dry atmosphere that does not contain moisture, and it suffices when the dew point is, for example, −40° C. or less or −50° C. or less. The carbon dioxide atmosphere can contain a gas other than carbon dioxide, but the mole fraction of carbon dioxide is desirably 80% or more, more desirably 95% or more. It is desirable that no oxidizing gas is contained, and it suffices when the mole fraction of oxygen is 0.1% or less.

To form a thicker first layer, it is efficient to set the partial pressure of carbon dioxide to, for example, greater than 0.5 atmospheric pressure (5.05×10⁴ Pa), and may be set to 1 atmosphere (1.01×10⁵ Pa) or more.

The temperature of the negative electrode exposed to the carbon dioxide atmosphere may be, for example, in the range of 15° C. to 120° C. The higher the temperature is, the thicker the first layer is formed.

The thickness of the first layer can be easily controlled by changing the time for which the negative electrode is exposed to the carbon dioxide atmosphere. The exposure time may be, for example, 12 hours or more, and is less than 10 days.

The step of forming a first layer is preferably performed before forming an electrode body, but this does not exclude the case of performing after forming an electrode body. That is, as a possible option, a positive electrode is prepared, a negative electrode having a negative electrode mixture layer with metal lithium attached thereto is prepared, a separator is interposed between the positive electrode and the negative electrode, to form an electrode body, and the electrode body is exposed to a carbon dioxide atmosphere, to form a first layer in the surface layer portion of the negative electrode mixture layer.

The step of pre-doping lithium ions into the negative electrode mixture layer is completed by, for example, subsequently bringing the negative electrode mixture layer into contact with the electrolyte to allow pre-doping to further proceed, and leaving to stand for a predetermined time. Such a step can be a process of forming a second layer so as to cover at least a part of the first layer. For example, by subjecting the electrochemical device to at least one cycle of charging and discharging, it is possible to form a second layer in the negative electrode mixture layer, and also to complete the pre-doping of lithium ions into the negative electrode. Alternatively, the pre-doping of lithium ions into the negative electrode can be completed by, for example, applying a predetermined charging voltage (e.g., 3.4 to 4.0 V) between the terminals of the positive electrode and the negative electrode for a predetermined time (e.g., 1 to 75 hours).

### (Positive Electrode)

The positive electrode includes a positive electrode active material into which anions are reversibly doped. The positive electrode active material is, for example, a carbon material, a conductive polymer, and the like. The positive electrode may include a positive electrode mixture layer containing a positive electrode active material, and a positive electrode current collector supporting the positive electrode mixture layer. The thickness of the positive electrode mixture layer is, although not limited to, for example, 10 to 300 μm per one side of the positive electrode current collector.

For the positive electrode current collector, a sheet-like metal material is used. The sheet-like metal material may be a metal foil, a metal porous body, an etched metal, and the like. As the metal material, aluminum, aluminum alloy, nickel, titanium, or the like can be used.

A carbon material that can be used as the positive electrode active material is preferably a porous carbon material, and desirably, an activated carbon. Examples of the raw material of the activated carbon include wood, coconut shells, coal, pitch, and phenolic resin. The activated carbon is preferably one subjected to activation treatment.

The average particle diameter of the activated carbon is, although not limited to, preferably 20 μm or less, more preferably 3 μm to 15 μm.

The specific surface area of the positive electrode mixture layer is approximately reflecting the specific surface area of the positive electrode active material. The specific surface area of the positive electrode mixture layer is, for example, 600 m²/g or more and 4000 m²/g or less, and desirably, 800 m²/g or more and 3000 m²/g or less.

The specific surface area of the positive electrode mixture layer is a BET specific surface area obtained using a measuring instrument conforming to JIS Z8830 (e.g., TriStar II 3020 available from Shimadzu Corporation). Specifically, the electrochemical device is disassembled, from which the positive electrode is taken out. Next, the positive electrode is washed with DMC and dried. Then, the positive electrode mixture layer is peeled off from the positive electrode current collector, to collect about 0.5 g of a sample of the positive electrode mixture layer. Next, the specific surface area of the collected sample is obtained using the same method as the already-described method for measuring the specific surface area of the negative electrode mixture layer.

The activated carbon desirably occupies 50 mass % or more, further 80 mass % or more, and further 95 mass % or more of the positive electrode active material. The activated carbon desirably occupies 40 mass % or more, further 70 mass % or more, and further 90 mass % or more of the positive electrode mixture layer.

The positive electrode mixture layer contains a positive electrode active material as an essential component, and contains a conductive agent, a binder, a thickener, and the like, as optional components. Examples of the conductive agent include carbon black, and carbon fibers. Examples of the binder include fluorocarbon resins, acrylic resins, and rubbery materials. Examples of the thickener include cellulose derivatives.

The positive electrode mixture layer is formed by, for example, mixing a positive electrode mixture containing a positive electrode active material, a conductive agent, and the like, with a dispersion medium, to prepare a positive electrode slurry, applying the positive electrode slurry to a positive electrode current collector, followed by drying.

The conductive polymer that can be used as the positive electrode active material is preferably a π-conjugated polymer. As the π-conjugated polymer, for example, polypyrrole, polythiophene, polyfuran, polyaniline, polythiophene vinylene, polypyridine, or a derivative thereof can be used. These may be used singly or in combination of two or more. The weight average molecular weight of the conductive polymer is, for example, 1000 to 100,000. The derivative of a π-conjugated polymer means a polymer whose basic backbone is a π-conjugated polymer, such as polypyrrole, polythiophene, polyfuran, polyaniline, polythiophene vinylene, and polypyridine. For example, a polythiophene derivative includes poly(3,4-ethylenedioxythiophene) (PEDOT), and the like.

The conductive polymer is formed by, for example, immersing a positive electrode current collector having a carbon layer, into a reaction solution containing a raw material monomer of the conductive polymer, and allowing electropolymerization of the raw material monomer to proceed in the presence of the positive electrode current collector. In the electropolymerization, the positive electrode current collector and a counter electrode are immersed in the reaction solution containing a raw material monomer, to apply a current between the two, with the positive electrode current collector used as an anode. The conductive polymer may be formed by a method other than electropolymerization. For example, the conductive polymer may be formed by chemical polymerization of the raw material monomer. In the chemical polymerization, the raw monomer is polymerized with an oxidizing agent or the like in the presence of the positive electrode current collector.

The raw material monomer used in the electropolymerization or chemical polymerization may be any polymerizable compound that can generate a conductive polymer by polymerization. The raw material monomer may include an oligomer. As the raw material monomer, for example, aniline, pyrrole, thiophene, furan, thiophene vinylene, pyridine, or a derivative thereof is used. These may be used singly or in combination of two or more. In particular, aniline can be easily grown on the carbon layer by electropolymerization.

The electropolymerization or chemical polymerization can be performed using a reaction solution containing anions (dopant). When doped with a dopant, the π-electron conjugated polymer can exhibit excellent conductive properties. Examples of the dopant include sulfate ions, nitrate ions, phosphate ions, borate ions, benzenesulfonate ions, naphthalenesulfonate ions, toluenesulfonate ions, methanesulfonate ions, perchlorate ions, tetrafluoroborate ions, hexafluorophosphate ions, and fluorosulfate ions. The dopant may be polymer ions. Examples of the polymer ions include ions of polyvinyl sulfonic acid, polystyrene sulfonic acid, polyallyl sulfonic acid, polyacrylic sulfonic acid, polymethacrylic sulfonic acid, poly(2-acrylamide-2-methylpropane sulfonic acid), polyisoprene sulfonic acid, and polyacrylic acid, and the like.

### (Separator)

The separator is disposed between the positive electrode and the negative electrode. The separator desirably contains, for example, an olefin-based resin. In the following, a separator containing an olefin-based resin is sometimes referred to as an “olefin-based separator.”

In an electrochemical device like a lithium-ion capacitor, a cellulose-based separator is typically used. This is because the cellulose-based separator has excellent electrolyte permeability, allowing pre-doping to easily proceed. On the other hand, the cellulose-based separator has a functional group, such as an OH group, that reacts easily with lithium ions and tends to contain moisture, and is therefore apt to be damaged by side reactions. The lithium pre-doped into the negative electrode may react with the separator, resulting in some cases in a reduced amount of the pre-doped lithium. In an environment where lithium carbonate is produced in the surface layer portion of the negative electrode mixture layer, the degradation of the cellulose-based separator tends to be severe.

In contrast, the olefin-based separator has a low moisture content, leading to suppressed degradation of the separator itself caused by moisture and of the negative electrode. The olefin-based separator is also excellent in stability against an electrolyte containing lithium ions and against pre-doped lithium. The olefin-based separator is unlikely to be degraded even in an environment where lithium carbonate is produced in the surface layer portion of the negative electrode mixture layer. Therefore, by using an olefin-based separator, the state where the internal resistance is low can be maintained over a long time. This results in improved float characteristics of the electrochemical device.

When pre-doping of lithium ions is performed while the positive electrode and the negative electrode are in the form of a wound body constituted by winding them with a separator interposed between the positive electrode and the negative electrode, the lithium ions leached out from the metal lithium which has been supplied for pre-doping are unlikely to diffuse throughout the wound body. In that case, it is difficult to use an olefin-based separator. On the other hand, by performing pre-doping while the negative electrode, in which metal lithium has been attached in advance to the entire surface of the negative electrode mixture layer, is in contact with an electrolyte, it is possible to perform pre-doping with respect to the whole wound body in a short time.

The olefin-based resin is a resin that contains an olefin unit as a major component. The olefin-based resin contains, for example, 50 mass % or more, and further 70 mass % or more of the olefin unit. The olefin unit refers to a monomer unit derived from olefin (alkene), such as ethylene, propylene, and butene. Here, the divalent group (diyl group) formed by polymerization of a monomer is referred to as a “unit” of that monomer. At least part of the olefin may be a derivative thereof. The olefin-based resin may be a homopolymer or a copolymer synthesized from a plurality of kinds of olefins. Part of the hydrogen atoms of the olefin may be substituted by a halogen atom. Examples of the olefin-based resin may include polyethylene (PE), polypropylene (PP), polymethylpentene (PMP), chlorinated polyethylene (CPE), ethylene-vinyl acetate copolymer (EVA), and ethylene-ethyl acrylate copolymer (EEA). In particular, at least one selected from the group consisting of polypropylene (PP) and polyethylene (PE) is preferred. A PP separator and a PE separator have high strength and are stable against an electrolyte containing lithium ions, and can be preferably used in an electrochemical device in which a first layer and a second layer are formed in the surface layer portion of the negative electrode mixture layer.

As a separator containing an olefin-based resin, for example, a microporous film, woven fabric, or nonwoven fabric made of polyolefin can be used. In particular, a microporous film, which is a non-fibrous porous film, has high strength and is suitable for thinning the thickness. The thickness of the separator is, for example, 8 to 40 μm, preferably 12 to 30 μm, more preferably 14 to 25 μm or 16 to 25 μm.

### (Electrolyte)

The electrolyte having lithium ion conductivity contains a lithium salt and a solvent for dissolving the lithium salt. Anions of the lithium salt are repeatedly and reversibly doped into and de-doped from the positive electrode. Lithium ions derived from the lithium salt are reversibly absorbed into and released from the negative electrode.

Examples of the lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(SO₂F)₂, and LiN(SO₂CF₃)₂. These may be used singly or in combination of two or more. In particular, a lithium salt having fluorine-containing anions is preferred in that the degree of dissociation is high, an electrolyte with low viscosity can be obtained, and the voltage withstanding characteristics of the electrochemical device can be improved.

The electrolyte preferably includes an imide-type electrolyte. The imide-type electrolyte contains imide-type anions as anions of the lithium salt. The imide-type anions may be anions containing fluorine and sulfur. In particular, lithium bis(fluorosulfonyl)imide, that is, LiN(SO₂F)₂(LiFSI) is preferably used. For example, 80 mass % or more of the lithium salt may be LiFSI.

LiFSI is considered to have an effect of reducing the degradation of the positive electrode active material and the negative electrode active material. Among the salts having fluorine-containing anions, FSI anions have excellent stability, and are considered to hardly produce byproducts and smoothly contribute to charging and discharging without damaging the surface of the active material. The SEI film formed by LiFSI in the surface layer portion of the negative electrode mixture layer contains a large amount of lithium fluoride, while the lithium carbonate content is small. Thus, a stable second layer which contains lithium fluoride as a major component can be formed so as to cover the first layer which contains lithium carbonate as a major component.

The concentration of the lithium salt in the nonaqueous electrolyte in a charged state (at a charge rate (SOC) of 90 to 100%) is, for example, 0.2 to 5 mol/L.

The solvent that can be used include: cyclic carbonates, such as ethylene carbonate, propylene carbonate, and butylene carbonate; chain carbonates, such as dimethyl carbonate, diethyl carbonate, and ethyl methyl carbonate; aliphatic carboxylic acid esters, such as methyl formate, methyl acetate, methyl propionate, and ethyl propionate; lactones, such as γ-butyrolactone and γ-valerolactone; chain ethers, such as 1,2-dimethoxyethane (DME), 1,2-diethoxyethane (DEE), and ethoxy methoxy ethane (EME); cyclic ethers, such as tetrahydrofuran, and 2-methyltetrahydrofuran; dimethyl sulfoxide; 1,3-dioxolane; formamide; acetamide; dimethylformamide; dioxolane; acetonitrile; propionitrile; nitromethane; ethyl monoglyme; trimethoxy methane; sulfolane; methyl sulfolane; 1,3-propanesultone; and the like can be used. These may be used singly or in combination of two or more.

Various additives may be added to the electrolyte, as necessary. For example, an unsaturated carbonate, such as vinylene carbonate, vinylethylene carbonate, and divinylethylene carbonate, may be added as an additive that forms a film with lithium ion conductivity on the surface of the negative electrode.

FIGURE schematically shows a configuration of an electrochemical device 200 according to one embodiment of the present invention. The electrochemical device 200 includes an electrode body 100, a liquid electrolyte (not shown) with lithium ion conductivity, a bottomed cell case 210 made of metal housing the electrode body 100 and the electrolyte, and a sealing plate 220 sealing the opening of the cell case 210. The electrode body 100 is configured as a columnar wound body obtained by winding a belt-like positive electrode 10 and a belt-like negative electrode 20, with a separator 30 interposed between the positive electrode 10 and the negative electrode 20. A gasket 221 is disposed around the peripheral edge of the sealing plate 220, and the open end of the cell case 210 is crimped onto the gasket 221, sealing the inside of the cell case 210.

The positive electrode 10 and the negative electrode 20 each have an exposed portion of the current collector at their ends along the longitudinal direction, and the exposed portions protrude from different end faces of the wound body. An exposed portion 11x of the positive electrode current collector is welded to a positive electrode current collecting plate 13 having a through-hole 13h in the center. The other end of a tab lead 15, one end of which is connected to the positive electrode current collecting plate 13, is connected to the inner surface of a sealing plate 220. Thus, the sealing plate 220 functions as an external positive electrode terminal. On the other hand, an exposed portion 21x of the negative electrode current collector is welded to a negative electrode current collecting plate 23. The negative electrode current collecting plate 23 is directly welded to a member for welding provided on the inner bottom surface of the cell case 210. Thus, the cell case 210 functions as an external negative electrode terminal.

The positive and negative electrode current collecting plates are each an approximately disc-shaped metal plate. The material of the negative electrode current collecting plate is, for example, copper, copper alloy, nickel, stainless steel, and the like. The material of the positive electrode current collecting plate is, for example, aluminum, aluminum alloy, titanium, stainless steel, and the like.

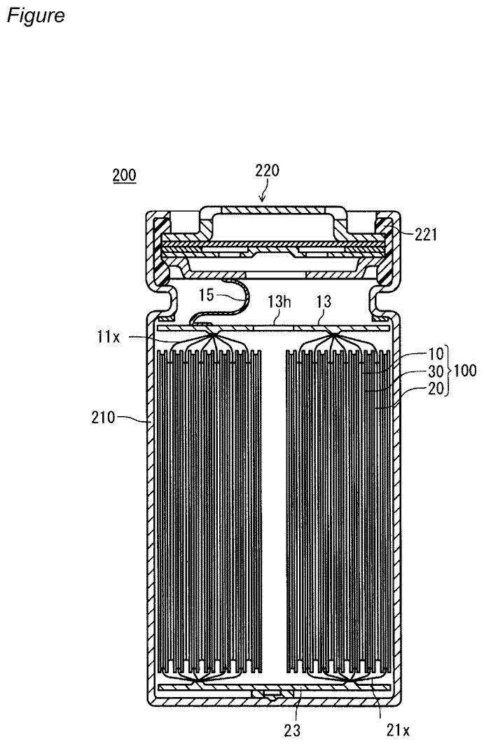

The electrochemical device is not limited to the wound electrochemical device shown in FIG. 1. For example, it may be a stacked electrochemical device. That is, the electrode body may be configured as a stack by stacking sheet-like positive and negative electrodes, with a separator interposed between the positive and negative electrodes.

### EXAMPLES

The present invention will be more specifically described below with reference to Examples. The present invention, however, is not limited to the Examples.

<<Electrochemical devices A1 to A7 and B1 to B9>>

### (1) Production of Positive Electrode

A 30-μm-thick aluminum foil (positive electrode current collector) was prepared. On the other hand, 88 parts by mass of activated carbon (average particle diameter 5.5 μm) serving as a positive electrode active material, 6 parts by mass of acetylene black (AB) serving as a conductive agent, 4 parts by mass of carboxymethyl cellulose (CMC) serving as a thickener, and 2 parts by mass of polytetrafluoroethylene (PTFE) serving as a binder were dispersed in water, to prepare a positive electrode slurry. The obtained positive electrode slurry was applied onto both surfaces of the aluminum foil, and the applied films were dried and rolled, into positive electrode mixture layers, to obtain a positive electrode. A positive electrode current collector-exposed portion having a width of 10 mm was formed at the end of the positive electrode current collector along the longitudinal direction.

### (2) Production of Negative Electrode

A 10-μm-thick copper foil (negative electrode current collector) was prepared. On the other hand, a total of 95 parts by mass of a negative electrode active material and a conductive additive, and a total of 5 parts by mass of an ammonium salt of carboxymethylcellulose (CMC) serving as a thickener and styrene butadiene rubber (SBR) serving as a binder were dispersed in water, to prepare a negative electrode slurry. The obtained negative electrode slurry was applied onto both surfaces of a copper foil, and the applied films were dried and rolled, into negative electrode mixture layers, to obtain a negative electrode. The negative electrode active material used here was non-graphitizable carbon (HC: average particle diameter 5 μm). The conductive additive used here was Ketjen black (KB: specific surface area 800 m²/g). The blending ratio between the negative electrode active material and the conductive additive was set to the values shown in Table 1. By changing the blending ratio between the negative electrode active material and the conductive additive, the specific surface area of the negative electrode mixture layer was adjusted to the values shown in Table 1.

Subsequently, a thin film of metal lithium for pre-doping was formed selectively on the center region of the negative electrode mixture layer, by vacuum deposition. The amount of lithium to be pre-doped was set so that the SOS-E and the SOC-C obtained by the already-described method became the values as shown in Table 1, and the negative electrode potential in the electrolyte after the completion of pre-doping became 0.2 V or less relative to metal lithium.

Subsequently, the chamber of the apparatus was purged with carbon dioxide to be a carbon dioxide atmosphere, to form a first layer containing lithium carbonate in the surface layer portion of the negative electrode mixture layer. The dew point of the carbon dioxide atmosphere was set to −40° C., the mole fraction of carbon dioxide was set to 100%, and the pressure in the chamber was set to 1 atmosphere (1.01×10⁵ Pa). The temperature of the negative electrode exposed to the carbon dioxide atmosphere at 1 atmosphere was set to 25° C. The time for exposing the negative electrode to the carbon dioxide atmosphere was set to 22 hours. The first layer was substantially free of F (or LiF).

The peeling strength of the negative electrode mixture layer from the negative electrode current collector was measured, which was all 0.04 N/mm or more.

### (Production of Electrode Body)

A single-layer microporous film (thickness 25 μm) made of polypropylene (PP), which was an olefin-based separator, was used as the separator.

The electrode body was formed by winding the positive electrode and the negative electrode in a columnar shape, with the separator interposed therebetween. At this time, the exposed portion of the positive electrode current collector was protruded from one end face of the wound body, while the exposed portion of the negative electrode current collector was protruded from the other end face of the electrode body. A disc-shaped positive electrode current collecting plate and a disc-shaped negative electrode current collecting plate were welded to the exposed portion of the positive electrode current collector and the exposed portion of the negative electrode current collector, respectively.

### (Preparation of Electrolyte)

A nonaqueous electrolyte was prepared by dissolving LiFSI as a lithium salt, in a mixed solvent (volume ratio 3:5:2) of ethylene carbonate (EC), ethyl methyl carbonate (EMC), and diethyl carbonate (DEC). The concentration of LiFSI in the nonaqueous electrolyte was set to 1.2 mol/L.

### (Fabrication of Electrochemical Device)

The electrode body was housed in a bottomed cell case having an opening. A tab lead connected to the positive electrode current collecting plate was connected to the inner surface of the sealing plate, and the negative electrode current collecting plate was welded to the inner bottom surface of the cell case. After injecting the nonaqueous electrolyte into the cell case, the opening of the cell case was sealed with a sealing plate. An electrochemical device as shown in FIG. 1 was thus fabricated. In Table 1, A1 to A7 are electrochemical devices of Examples 1 to 5, and B1 to B9 are electrochemical devices of Comparative Examples 1 to 9.

This was followed by aging performed at 60° C. with a charging voltage of 3.8 V applied between the terminals of the positive electrode and the negative electrode, to complete pre-doping of lithium ions into the negative electrode.

With respect to each of the electrochemical devices of Examples and Comparative Example, the following evaluations were performed.

### [Evaluation 1: Measurement of Initial Internal Resistance (DCR) of Electrochemical Device]

The electrochemical device immediately after the aging was subjected, in a −30° C. environment, to a constant-current charging at a current density of 2 mA/cm² per positive electrode area until the voltage reached 3.8 V, and then was held for 10 minutes with the voltage of 3.8 V applied thereto. Then, in a −30° C. environment, the electrochemical device was subjected to a constant-current discharging at a current density of 2 mA/cm² per positive electrode area until the voltage reached 2.2 V.

Using the discharge curve (vertical axis: discharge voltage, horizontal axis: discharge time) obtained from the above discharging, a linear approximation line was obtained in the range of 0.5 seconds to 2 seconds after the start of discharging in the discharge curve, and a voltage VS at the intercept with the approximate line was obtained. The value (V0-VS) obtained by subtracting the voltage VS from a voltage V0 at the start of discharging (0 seconds after the start of discharging) was calculated as ΔV. Using ΔV (V) and a current value Id (current density 2 mA/cm² per positive electrode area x positive electrode area) during discharging, an internal resistance (DCR) R1 (mΩ) of the electrochemical device was calculated from the following equation (A). This was determined as an initial DCR. The relative values, with the initial DCR of the electrochemical device of Comparative Example 2 taken as 100, are shown in Table 1.

$$Internal resistance R 1 = 1000 \times Δ V / Id \qquad ( A )$$

### [Evaluation 2: Evaluation of Reliability (Float Characteristics) of Electrochemical Device]

Next, in an 85° C. environment, the electrochemical device was held with a constant voltage of 3.8 V applied thereto, for a long time. At the lapse of 1000 hours, the electrochemical device was taken out, and discharged at a current of 5.0 A to a voltage of 2.5 V. In the midway, the quantity of discharged electricity flown during when the voltage dropped from 3.3 V to 3.0 V was measured, and divided by the voltage change ΔV (=0.3 V), to determine a capacity C1 (F). The change rate of the capacity after continuous charging, relative to a capacity C0 before continuous charging (initial) was calculated by C1/C0×100. A larger change rate means that the rise in internal resistance is more suppressed, the float characteristics are more excellent, and the reliability is higher. The relative values, with the initial DCR of the electrochemical device of Comparative Example 3 taken as 100, are shown in Table 1.

### [Evaluation 3: Evaluation of Metal Lithium Deposition State]

The electrochemical device having been subjected to the evaluation of reliability was disassembled, to observe the metal lithium deposition state in the end regions of the negative electrode mixture layer. When metal lithium was clearly observed by visual inspection, this was rated as “present”, when metal lithium was only slightly observed, this was rated as “slight”, and when metal lithium was not observed at all, this was rated as “none”.

The evaluation results are shown in Table 1.

TABLE 1

| | specific | | | initial | reliability | |
|---|---|---|---|---|---|---|
| | surface area | SOC-C | SOC-E | DCR | (change | Li |
| | (m²/g) | (%) | (%) | R1 (mΩ) | rate) | deposition |
| B1 | 5 | 90 | 90 | 133 | 103 | none |
| B2 | 10 | 90 | 90 | 100 | 102 | present |
| B3 | 30 | 90 | 90 | 80 | 100 | present |
| B4 | 50 | 90 | 90 | 67 | 102 | present |
| B5 | 70 | 90 | 90 | 63 | 100 | present |
| B6 | 100 | 90 | 90 | 62 | 102 | present |
| B7 | 100 | 70 | 70 | 65 | 57 | none |
| B8 | 30 | 70 | 70 | 90 | 60 | none |
| B9 | 30 | 50 | 50 | 110 | 30 | none |
| A1 | 30 | 95 | 80 | 82 | 109 | none |
| A2 | 30 | 95 | 70 | 84 | 100 | none |
| A3 | 50 | 95 | 70 | 67 | 100 | none |
| A4 | 70 | 95 | 70 | 64 | 99 | none |
| A5 | 30 | 85 | 70 | 84 | 93 | none |
| A6 | 30 | 95 | 90 | 82 | 106 | slight |
| A7 | 30 | 95 | 50 | 95 | 70 | none |

In the electrochemical device B1, no deposition of metal lithium was observed, but the initial DCR was large. In other words, when the specific surface area of the negative electrode mixture layer is a normal size, deposition of metal lithium is unlikely to become an issue even though X<Y is not satisfied, but on the other hand, the internal resistance increases.

In the electrochemical devices B2 to B7, deposition of metal lithium in the end regions of the negative electrode mixture layer was noticeable. This was presumably because, despite the specific surface area of the negative electrode mixture layer being large, X<Y was not satisfied.

In the electrochemical devices B8 and B9, the reliability was significantly reduced. This was presumably because the amount of pre-doped lithium ions in the negative electrode mixture layers was insufficient, causing the internal resistance to increase.

In the electrochemical devices A1 to A5, the initial DCR was low, and the reliability was significantly improved. Also, no deposition of metal lithium was observed.

In the electrochemical device A6, slight deposition of metal lithium was observed.

In the electrochemical device A7, no deposition of metal lithium was observed, but the reliability was reduced.

### [Evaluation 4: XPS Analysis of Surface Layer Portion of Negative Electrode Mixture Layer]

The surface layer portion of the negative electrode mixture layer after the exposure to a carbon dioxide atmosphere was analyzed by XPS, for the C1s, O1s, and Li1s spectra. For the analysis, an X-ray photoelectron spectrometer (product name: Model 5600, available from ULVAC-PHI, Inc.) was used. The measurement conditions are shown below.
X-ray source: A1-mono (1486.6 eV) 14 kV/200 W
Measurement diameter: 800 μmφ
Photoelectron take-off angle: 45°
Etching conditions: accelerating voltage 3 kV, etching rate approx. 3.1 nm/min
   (SiO₂ conversion), raster area 3.1 mm×3.4 mm

The result of the analysis of the C1s, O1s, and Li1s spectra confirmed that the thickness of the first layer was approximately 18 nm. Specifically, peaks of the C—C bond and the like which were presumed to be attributed to impurity carbon were observed on the outermost surface, but they became drastically small around 1 to 2 nm deep in the first layer. On the other hand, a first peak attributed to the C═O bond was observed from the outermost surface of the surface layer portion to a depth of 18 nm. A peak attributed to the Li—O bond was also observed from a depth of around 18 nm. Furthermore, the presence of Li was constantly confirmed from the outermost surface of the surface layer portion to a depth of 18 nm. No peak attributed to LiF was observed.

The surface layer portion of the negative electrode mixture layer of the negative electrode taken out from the electrochemical device was analyzed by XPS in the same manner as above. The result confirmed that a SEI layer (second layer) having a thickness of 10 nm was formed, which had a different composition from the first layer and was distinguishable from the first layer. In addition, a peak attributed to LiF was observed.

### (Supplementary Notes)

The above description of embodiments discloses the following techniques.

### (Technique 1)

An electrochemical device, comprising
a positive electrode, a negative electrode, a separator, and a lithium-ion conductive electrolyte, wherein
the positive electrode includes a positive electrode current collector, and a positive electrode mixture layer which is supported on the positive electrode current collector and into which anions are reversibly doped,
the negative electrode includes a negative electrode current collector, and a negative electrode mixture layer which is supported on the negative electrode current collector and into which lithium ions are reversibly doped,
a length L1 of the negative electrode mixture layer in a first direction is longer than
a length L2 in a second direction orthogonal to the first direction, a state of charge of two end regions adjacent to both ends of the negative electrode mixture layer in the second direction is X %,
a state of charge of a center region of the negative electrode mixture layer in the second direction is Y %, and
X<Y is satisfied.

### (Technique 2)

The electrochemical device according to technique 1, wherein a specific surface area of the negative electrode mixture layer is 10 m²/g or more and 70 m²/g or less.

### (Technique 3)

The electrochemical device according to technique 1 or 2, wherein a specific surface area of the negative electrode mixture layer is 20 m²/g or more and 60 m²/g or less.

### (Technique 4)

The electrochemical device according to any one of techniques 1 to 3, wherein
the negative electrode mixture layer contains carbon black as a conductive additive, and
a specific surface area of the conductive additive is 800 m²/g or more.

### (Technique 5)

The electrochemical device according to any one of techniques 1 to 4, wherein a ratio of a mass of the conductive additive to a mass of the negative electrode mixture layer is 2% or more and less than 15%.

### (Technique 6)

The electrochemical device according to any one of techniques 1 to 5, wherein when a potential difference between the positive electrode and the negative electrode is 3.0 V, a difference (Y−X) between X and Y is 5% or more and 30% or less.

### (Technique 7)

The electrochemical device according to technique 1 any one of techniques 1 to 6, wherein when a potential difference between the positive electrode and the negative electrode is 3.0 V, 65%≤X≤85% and 75%≤Y≤95% are satisfied.

### (Technique 8)

The electrochemical device according to any one of techniques 1 to 7, wherein the negative electrode mixture layer contains hard carbon as a negative electrode active material.

### (Technique 9)

The electrochemical device according to any one of techniques 1 to 8, wherein the positive electrode mixture layer contains activated carbon as a positive electrode active material.

### (Technique 10)

The electrochemical device according to any one of techniques 1 to 9, wherein a surface layer portion of the negative electrode mixture layer has a first layer containing lithium carbonate.

### (Technique 11)

The electrochemical device according to any one of techniques 1 to 10, wherein
the surface layer portion of the negative electrode mixture layer has a second layer containing a solid electrolyte, and
at least part of the second layer covers at least part of a surface of the negative electrode mixture layer via the first layer.

### (Technique 12)

The electrochemical device according to any one of techniques 1 to 11, wherein
the second layer contains lithium carbonate, and
an amount of the lithium carbonate contained in the second layer is smaller than an amount of the lithium carbonate contained in the first layer.

### (Technique 13)

The electrochemical device according to any one of techniques 1 to 12, wherein the separator contains an olefin-based resin.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The electrochemical device according to the present invention is suitable for in-vehicle use, for example.

### REFERENCE SIGNS LIST

100: electrode body
10: positive electrode
11x: exposed portion of positive electrode current collector
13: positive electrode current collecting plate
15: tab lead
20: negative electrode
21x: exposed portion of negative electrode current collector
23: negative electrode current collecting plate
30: separator
200: electrochemical device
210: cell case
220: sealing plate
221: gasket

1. An electrochemical device, comprising
a positive electrode, a negative electrode, a separator, and a lithium-ion conductive electrolyte, wherein
the positive electrode includes a positive electrode current collector, and a positive electrode mixture layer which is supported on the positive electrode current collector and into which anions are reversibly doped,
the negative electrode includes a negative electrode current collector, and a negative electrode mixture layer which is supported on the negative electrode current collector and into which lithium ions are reversibly doped,
a length L1 of the negative electrode mixture layer in a first direction is longer than a length L2 in a second direction orthogonal to the first direction,
a state of charge of two end regions adjacent to both ends of the negative electrode mixture layer in the second direction is X %,
a state of charge of a center region of the negative electrode mixture layer in the second direction is Y %, and
X<Y is satisfied.

2. The electrochemical device according to claim 1, wherein a specific surface area of the negative electrode mixture layer is 10 m²/g or more and 70 m²/g or less.

3. The electrochemical device according to claim 1, wherein a specific surface area of the negative electrode mixture layer is 20 m²/g or more and 60 m²/g or less.

4. The electrochemical device according to claim 1, wherein
the negative electrode mixture layer contains carbon black as a conductive additive, and
a specific surface area of the conductive additive is 800 m²/g or more.

5. The electrochemical device according to claim 4, wherein a ratio of a mass of the conductive additive to a mass of the negative electrode mixture layer is 2% or more and less than 15%.

6. The electrochemical device according to claim 1, wherein when a potential difference between the positive electrode and the negative electrode is 3.0 V, a difference (Y−X) between X and Y is 5% or more and 30% or less.

7. The electrochemical device according to claim 1, wherein when a potential difference between the positive electrode and the negative electrode is 3.0 V, 65%≤X≤85% and 75%≤Y≤95% are satisfied.

8. The electrochemical device according to claim 1, wherein the negative electrode mixture layer contains hard carbon as a negative electrode active material.

9. The electrochemical device according to claim 1, wherein the positive electrode mixture layer contains activated carbon as a positive electrode active material.

10. The electrochemical device according to claim 1, wherein a surface layer portion of the negative electrode mixture layer has a first layer containing lithium carbonate.

11. The electrochemical device according to claim 10, wherein
the surface layer portion of the negative electrode mixture layer has a second layer containing a solid electrolyte, and
at least part of the second layer covers at least part of a surface of the negative electrode mixture layer via the first layer.

12. The electrochemical device according to claim 11, wherein
the second layer contains lithium carbonate, and
an amount of the lithium carbonate contained in the second layer is smaller than an amount of the lithium carbonate contained in the first layer.

13. The electrochemical device according to claim 1, wherein the separator contains an olefin-based resin.
